(19) United States
(12) Patent Application Publication
(10) Pub. No.: US 2025/0065768 A1
(43) Pub. Date: Feb. 27, 2025

(54) Method for checking charging stations and their functional scope

(71) Applicant: eClever technology GmbH, Dresden (DE)

(72) Inventor: Oliver Raguse, Bannewitz (DE)

(21) Appl. No.: 18/718,815

(22) PCT Filed: Dec. 12, 2022
(86) PCT No.: PCT/EP2022/085470

§ 371 Date: Jun. 12, 2024

(30) Foreign Application Priority Data
Dec. 12, 2021 (LU) 500992

(51) Int. Cl. B60L 53/68; G01M 99/00

(52) U.S. Cl. CPC B60L 53/68; G01M 99/005

(57) ABSTRACT

The present invention relates to a method for checking charging stations and their functional scope by vehicle-side or charging station-side detection of relevant parameters and faults occurring during a charging process of an electric vehicle at a charging station.

### TECHNICAL FIELD

The present invention relates to a method for monitoring and reporting faults and deviations in charging stations for electric vehicles.

### STATE OF THE ART

During the introduction of the first vehicles with internal combustion engines, fuel could only be purchased from pharmacies. As motor vehicles were not widely available at that time anyway, vehicle operators were generally familiar with the detours. Over the decades, the picture has changed. There are filling stations in almost every town and at regular intervals along the highways, and vehicles with combustion engines have a range with one tank of fuel that means they often need to be refueled less than once a week in everyday use.

For around half a decade, due to an increasing number of consumers who are concerned about the environment, as well as political guidelines, vehicles with an electric drive train or electrically assisted drive train and an accumulator have also been gaining ground.

Due to the lack of demand, the expansion of the charging infrastructure, i.e. the expansion of the necessary charging stations for charging electric vehicles in public spaces, was initially sporadic and often only on the initiative of small companies or municipal bodies such as public utilities.

At least in the initial phase of the expansion of the charging infrastructure, the charging stations were manufactured by companies that had enormous expertise in the construction of high-voltage technology, etc., but lacked a corresponding expertise in digital matters with regard to software development.

As a result, the first charging stations were extremely insecure in terms of IT security aspects. The established billing procedures also offer no security and most of the charging stations also lack a suitable device for regularly checking the integrity and functionality of the charging station and sending the determined status to the operator.

The most widespread billing method relies on reading a public feature of an RFID card, so-called Mifare Classic cards, whose encryption methods have been considered completely insecure since 2008. These cards can be copied with the simplest of means. Regardless of the poor encryption, only the ID of the card, i.e. a supposedly unique code number of the card that is public, is often used for billing. Thus, an attacker can read cards in the public space or by attacking a charging station, whereby the data stored in a charging station (e.g. identification numbers of various cards and payment information) can also often be easily read through diagnostic ports. In addition, the connection of a charging station to the infrastructure of the charging station operator, which for example provides a charging station directory or the billing interfaces, is often insufficiently encrypted.

Due to the plurality of different charging station operators, it is also often unclear to the user to whom they should turn in the event of a defect of the charging station. Operators with a large number of charging stations partly offer telephone support. This can sometimes be remedied by rebooting the charging station or activating it remotely. Unfortunately, vehicle operators of electric vehicles are usually left to their own devices, especially when using charging stations from smaller providers or at night. In practice, they therefore often move on in resignation and don not even bother with telephone support. Defective charging stations are sometimes not recognized as defective and repaired for weeks.

As an example, U.S. Pat. No. 11,167,655B2 discloses a wired charging station that can report a fault condition to the user via a light source. However, the patent specification does not disclose any possibility of how someone other than the user, in particular the charging station operator, is informed of a fault condition. The EP3119637B1, on the other hand, discloses a method for coupling an induction charging system, which can also be interrupted in the event of a fault without the fault being reported to an operator.

The US20210354584A1, on the other hand, discloses a charging station comprising an output device, wherein the output device can, for example, also send an e-mail to the charging station operator when a fault condition occurs. Advantageously, this ensures at least an automatic message to the charging station operator. However, the document does not disclose an automatic message to charging station directories operated by third parties.

Furthermore, it does not record whether the charging station is blocked by vehicles that are not charging and, last but not least, a considerable amount of measurement technology is required to implement the method, with which all charging stations that wanted to implement the method would have to be equipped.

Central charging station directories bundle information on charging stations, sometimes on the basis of data provided by the charging station operators themselves, sometimes on the basis of data compiled by an online community.

A well-known online community called “GoingElectric” provides such a database. In addition to accessing information on charging stations, users can also report faults at a charging station on the website so that other electric vehicle operators are not also confronted with the same defective charging station.

However, this solution, like the telephone hotline solution, requires time and effort on the part of the user and also has the disadvantage that the information about the outage does not automatically reach the charging station operator.

In addition, it happens again and again that the position of a charging station is incorrectly stored in the charging station directory after it has been installed, or that previously existing charging stations are at least temporarily or permanently dismantled without this information being stored in the charging station directory. As a result, electric vehicle operators again and again reach places where a charging station is supposed to be located but cannot be found.

Furthermore, it also regularly happens that a charging station is listed with a certain charging capacity, which the model on site does not actually have.

In DE 10 2017 215 794 A1, a method for context-based support of a charging process of the electrical energy storage system of partially electrically powered vehicles, in particular of plug-in hybrids, is disclosed. The method described is triggered by a refueling process of the fuel tank of such a vehicle. When it is detected that the electrical energy storage falls below a predefined threshold value, a charging station in a certain geographical area is determined. Herein, a suitable, nearby, unassigned charging station is sent to a device or an app of the user. Herein, the data is taken from a central database. However, errors in the database can lead to the user receiving incorrect information.

A different approach is taken in US 2020/0219019 A1, which describes a device and a method using artificial intelligence. A reservation system for charging stations is proposed that supports customers to recognize when certain charging stations are occupied or free. For this, time slots can be requested and then reserved. However, errors in the position of the charging stations or in their other properties, such as charging voltage or similar, can neither be detected nor corrected here.

In DE 10 2020 127 146 A1, mobile charging stations and a method for the production and use of such mobile charging stations are described. The charging station described uses a fuel cell to generate the necessary electrical energy from hydrogen, which is stored in a tank. Due to the special design and the possibility of completely dispensing with a connection to a general electrical supply network, the mobile charging station can be relocated and thus set up at various suitable locations, such as a park, even temporarily. The method enables suitable route planning using the location data of the charging stations. The location data can be transmitted using radio beacons, for example. Routes and the use of charging stations can be planned using various parameters. Fault detection is not provided for.

From CN 113580986 A, a method and a monitoring device for checking and monitoring a charging station are known, in which a certain area is first preselected. The method allows monitoring of certain charging variables, for example current, voltage or power of the charging facility, by means of the monitoring device. Values that deviate from a certain tolerance are stored in a cloud as abnormal values directly initiated by the charging station provider. Disadvantageously, all charging stations must be equipped with this device in order to be subject to checking at all. This results in high costs. Furthermore, charging stations can only be checked during the charging process.

A monitoring platform for detecting faults in charging stations is described in CN 113400987 A. It compares historical data from the charging stations with current charging values in order to detect deviations. Disadvantageously, a checking of the respective station is only initiated when the vehicle to be charged is connected. This also determines the probability that a fault may occur.

From WO 2021/028615 A1 a method and a device for monitoring a charging station is known. A monitoring platform is used which uses a self-learning system in which a faulty deviation can be reliably detected using incoming measurement data. A probability of a future failure can also be determined, using the charging time in particular. Disadvantageously, a missing charging station cannot be detected here.

Furthermore, a mobile checking system for car charging stations is disclosed in DE 10 2014 013 870 A1. An electrotechnical check device for monitoring and surveilling charging stations is installed in a vehicle for this purpose. It enables errors to be determined and forwarded, for example by comparing them with predetermined charging curves. If a deviation is outside a certain tolerance, a fault is forwarded to a database.

A method for monitoring vehicles is disclosed in US 2021/0122257 A1. The method described detects faulty charging stations. A large number of parameters, such as the past charging behavior of the charging station, are taken into account. It can be detected here if the charging behavior of a charging station is lower than would be expected under the given circumstances, so that the charging station is classified as faulty. Disadvantageously, lower charging performance can detect information about certain faults in the charging stations, but a missing station or a faulty location cannot be detected here.

### Objective

The present invention is therefore based on the objective of providing a method that checks data reported by charging station operators, compares it with the actual situation on site and reports any deviations and defects to the operator in order to improve the quality of the data accessible via charging station directories and contribute to a rapid rectification of faults.

### Solution

According to the invention, this objective is solved by a method for checking charging stations and their functional scope, which comprises the following steps:
Defining (S01) at least a relevant region for which at least a charging station is to be checked,
Retrieving (S02) at least an available information about at least a charging station, in particular this charging station, in the relevant region,
Determining (S03) the intention of a vehicle operator to use a charging station in the relevant region,
Testing (S04) of a charging process,
Identifying (S05) the charging station for which the charging process has been notified,
Vehicle-side and/or charging station-side detection (S06) of relevant parameters such as location, voltage, current or other variables influencing the charging process, preferably during the charging process,
Comparing (S07) the detected data of the relevant parameters during the charging process with at least an available information on the charging station used,
Reporting (S08) the deviation of the detected expected parameters from the expected parameters and the reporting of defects.

Further, the method is supported by one or more devices for implementing at least steps S06 to S08.

### General Advantages

Advantageously, the method ensures that human errors in the initial collection of data on charging stations and any defects that arise afterwards can be detected, reported and corrected as quickly as possible. The skilled person skilled also knows that approximately 5% of the vehicles used in the region under consideration are required for an appropriate detection of traffic data for consideration during navigation, for example to include delays caused by a traffic jam. Thus, it can be assumed that it would already be sufficient if a low percentage of all vehicles were equipped with a suitable device for implementing step S06 in order to detect faults at all existing charging stations across the board without them requiring their own measurement technology.

Further advantages can be found in the description and the embodiments.

### DETAILED DESCRIPTION OF THE INVENTION

In a preferred embodiment, the method for testing charging stations (3) and their functional scope comprises the following steps:
a) Defining (S01) at least a relevant region for which at least a charging station (3) (also referred to herein as the “primary charging station”) is to be checked,
b) Retrieving (S02) at least an available information from at least a charging station (3) in the relevant region, wherein the retrieving (S02) preferably being performed by a receiver or transceiver, in particular by a receiver or transceiver of the vehicle;
c) Determining (S03) the intention of a vehicle operator to use a charging station (3), in particular this charging station (3), in the relevant region, wherein a probability of an available intention is determined from the retrieved information, wherein the determining (S03) is preferably carried out by a computing unit, in particular by a driver guidance system, wherein the information is at least selected from the group comprising location, maximum charging power, available plug types, maximum voltage, maximum current, access requirements, operator, electricity costs or the like;
d) Testing (S04) of a charging process if the intention of a vehicle operator to use a charging station has been established (determined) with sufficient probability,
e) Identifying (S05) the charging station (3) for which the charging process has been notified,
f) vehicle-side and/or charging station-side detection (S06) of at least a relevant parameter, in particular a relevant parameter of the charging station and/or the vehicle, wherein the detection preferably being carried out by vehicle-side and/or charging station-side sensors or actuators,
g) Comparing (S07) the detected data of the relevant parameters, preferably during the charging process, with at least an available information on the charging station used, which is stored in a database, for example, wherein the comparison preferably being carried out by a computing unit,
h) Reporting (S08) the deviation of the detected data of relevant parameters from the expected parameters and/or reporting defects, wherein the reporting is preferably carried out by a transmitter or transceiver.

The method according to the invention comprises defining at least a relevant region for which at least a charging station or a plurality of charging stations are to be checked. Defining at least a relevant region represents a restriction of the charging stations to be considered and serves in particular for technical optimization. If all charging stations worldwide were to be checked regularly, this would lead to more traffic, i.e. larger amounts of data being transmitted. Advantageously, the restriction to one region is therefore associated with a saving in the amount of data transmitted. In principle, however, it would also be conceivable to load the data for the whole world.

In addition, the number of charging stations to be checked for the following steps can be advantageously reduced, whereby less computing power is required. Furthermore, the lower traffic advantageously reduces the hardware requirements both on the network side and in the technical design of the server or servers that the charging station operators or charging station directories have to maintain in order to answer the requests of the users of the method.

Preferably, defining (S01) the relevant region is based on the position or position data of the vehicle (i.e. based on the current location of the user) and/or on a map, in particular a digital map, wherein the region, in particular the road section within this region, is preferably assigned one or more possible intentions of a vehicle operator (driving intentions). The method may therefore also provide for determining a position of the vehicle prior to defining (S01) the relevant region. In some embodiments, determining the position of the vehicle corresponds to a satellite-based determination of the position. The satellite-based determination of the position of the vehicle enables the use of digital maps, which may already be available for navigation applications, for example.

In the specific design of the restriction to a relevant region or relevant regions, there is a conflict of objectives. In order to optimize the method according to the invention as much as possible, i.e. to maximize the probability of detecting a defective charging station, not too many charging stations must be filtered out in advance of the subsequent steps.

If the vehicle operator of the electric vehicle is already on a planned route from a starting point A to a target point B, a distinction must be made between two cases:

First: Insofar as at least a charging station is already planned along a route, the following considerations can be limited to the charging stations planned along the route. Since a device for recording the relevant parameters such as voltage, current, charging power, power loss, battery temperature, ambient temperature, degradation state of the battery, etc. must be installed in the vehicle during the charging process anyway, this device can also continuously monitor the “State of Charge” (SoC), i.e. also while driving, and thus monitor the battery level. (battery charge level) and thus prompt the vehicle operator to reschedule his route via another charging station, eliminating the need to consider the relevance of other charging stations for the next steps.

Second: If no charging stations are planned along the route, it must be assumed that the vehicle operator will spontaneously want to visit a charging station along the route.

In this case, an arbitrary polygon or any number of at least partially overlapping polygons can be spanned around the entire route. Polygons in this sense would also be ellipses or circles or other “round” shapes.

Preferably, a so-called bounding box should be applied as a polygon, which defines a geographical region by a minimum and maximum geographical longitude as well as a minimum and maximum geographical latitude, whereby a spherical rectangle is spanned. In the so-called Mercator projection and some other map projections (also known as map mesh design or map mapping), these bounding boxes appear as rectangles. In reality, however, the lines of longitude and latitude that delimit the bounding box are not straight, but curved lines on a great circle (with an approximation of the earth as a sphere using spherical coordinates), which is why in reality it is not a simple rectangle, but a spherical rectangle.

For further optimization, especially for long routes, bounding boxes can be drawn around individual route sections, preferably around each individual section on a route between two turns, so that, for example, a route from Berlin to Lake Constance does not take half of Germany into account, but only small corridors between two waypoints. As turns for determining the route sections can optionally be used all turns, or preferably only places, where the vehicle operator has to change from the road to another road.

A query based on bounding boxes is particularly preferred because they enable a particularly fast and simple query in the charging station directory databases with corresponding indices on databases. The skilled person understands an index in a database to be an index structure in a database that is separate from the data structure and speeds up searching and sorting by specific fields.

In the case that the vehicle operator has not planned any route, only a few optimizations can be made. In this case, too, queries within regions, preferably bounding boxes, can be used on the basis of the previous considerations in order to speed up the query advantageously.

Herein, a bounding box should be selected that contains the position of the vehicle. In a first consideration, the position of the vehicle could be in the center of the bounding box and the bounding box could have a fixed spread along the latitude and longitude, e.g. 20 km along the latitude and 20 km along the longitude. As a further optimization, a conversion factor can be converted from the selected unit of length to a delta in the latitude and longitude at the start of the journey based on the latitude, so that the recalculation of the bounding box is advantageously accelerated during the journey. Preferably, the bounding box can be selected to be longer along the direction of travel than in the direction orthogonal to the direction of travel, depending on the direction of travel and speed. Furthermore, the bounding box on the rear of the vehicle can preferably be shorter, i.e. the vehicle can be shifted off-center relative to the bounding box

Regardless of the region chosen for the selection of charging stations, it must be ensured that the vehicle does not leave it. Preferably, this is done by regularly monitoring the evaluation of the vehicle's position. Particularly preferably, this is done every time the vehicle's position is evaluated. The skilled person knows that when using the highest precision of a GPS module, a new so-called GPS fix is usually available for processing approximately once per second. A GPS fix comprises information such as at least a position in geographical coordinates, and possibly also altitude and/or speed etc. Alternatively to localized regular checking, there is also the possibility of checking at regular intervals whether the vehicle is still in the region.

In the step of retrieving the data (S02), information on the charging stations located within the relevant region defined in the step of defining the relevant region (S01) is loaded from at least one charging station directory. This comprises, for example, the location, in particular the location and maximum charging power, the model, the occupancy status, any known defects, the operator, etc. The electricity costs or the plug type or access requirements can also be retrieved. Based on this information, one or more suitable charging stations are then suggested to the user.

In the data retrieving step (S02), data transmissions and thus transmitted data volume can be saved again or traffic can be reduced. For example, only information about the charging stations that has changed is retrieved. Thus, for example, by transmitting a timestamp or using an HTTP GET request with an If-Unmodified-Since header on an If-None-Match header, a request can be sent to the charging station directory, whereupon only those entries and/or information on the charging stations are retrieved again that have changed at least partially since the last retrieval. HTTP requests (HTTP: Hyper Text Transfer Protocol) are a means of communication between computers in a network. In the HTTP specification, various so-called header fields are defined, which contain standardized information on how the request is to be processed. The two headers mentioned each offer a way to check whether the requested content has changed when the requested server requests information. By using other techniques such as checksum calculations, it would also be possible to ensure that already known information is not reloaded by sending the checksums of the known information to the server with requests in order to enable a server-side check for changes and subsequently only receive new information in response.

Once the charging stations potentially relevant for a charging process and relevant information about them have been retrieved on the basis of a relevant region, the intention of a vehicle driver to use or approach a charging station must be determined. This is preferred in order to ask the vehicle operator for feedback on the charging station in question, but advantageously to avoid too many queries. In the case of a route with planned charging stations, this is basically already described above. By restricting the selection to charging stations near the route and their accessibility, the choice is already significantly reduced. If charging stations are already planned, it is already known which charging stations the vehicle operator wants to drive to.

According to a preferred embodiment, the step of determining (S03) the intention of a vehicle driver to drive to and/or use a charging station on the basis of a planned route are carried out. This allows the probability to be determined, in particular from the information retrieved in the course of this. For example, the charging station has even been defined as an intermediate destination or final destination.

When a route is planned and driven, it must be increasingly assumed that charging stations along the route will become more and more relevant as the SoC decreases.

The following considerations also apply both in the event that a route without charging stations is planned and in the event that the vehicle operator is traveling without a planned route: Charging stations that can no longer be reached due to the low SoC preferably lose relevance completely. Depending on user preferences or vehicle driver profiles detected, charging stations that can be reached with an SoC of between 5% and 20% must be considered particularly relevant. Especially on long-distance trips on a highway, it can be assumed that a vehicle operator would like to use a charging station if, for example, he drives up to a rest area with a charging station. Furthermore, it can be assumed that if the vehicle operator has covered a longer distance, for example more than 100 km in one go, he is on a long-distance journey and would prefer to use fast-charging stations. In addition, charging stations can be positively weighted or discriminated against on the basis of the costs incurred by the vehicle operator or the expected time required for charging. These vary depending on the possible charging power and the operator of the charging station as well as the charging current provider (Mobility Service Provider, MSP) used by the vehicle operator.

In the event of a deviation from a planned route, it can also be assumed that the reason for leaving the route may be the search for a charging station.

When weighing up the above criteria, an algorithm can either be used to calculate an abstract cost function and optimize it, or artificial intelligence, in particular machine learning, can be used to predict the vehicle operator's plans. In doing so, other parameters or criteria described herein can also be taken into account.

It determines the probability that a driver will want to drive to a particular charging station.

In one embodiment, determining (S03) the intention of a vehicle driver may further be performed via a driver guidance system, in particular via a navigation function on a computing unit, of the vehicle. The driver guidance system, in particular the navigation function, can provide strong indicators for an intention of a vehicle driver, which are used to determine a probability of an intention of a vehicle driver, since a route, in particular turning decisions, can be specified or predicted based on the navigation function. The driver guidance system can also include the fill level of the vehicle for determining the intention, in particular for determining the probability. A driver guidance system also allows, for example, a route to be adapted according to the change in the vehicle's fill level, e.g. by changing and/or adding intermediate destinations (e.g. charging stations).

Decision parameters (so-called “trigger variables”) for determining the intention (S03) of a vehicle driver to use and/or control a charging station in the relevant region can, in at least some embodiments, be provided by the on-board sensor system (e.g. via the fill level of the vehicle). For this purpose, the step of determining (S03) the intention of a vehicle driver to use a charging station can be based on the characteristics of a vehicle. In addition, external signal sources, such as vehicle-to-vehicle information from other road users (e.g. about stalled or stopped traffic situations, closures) or from roadside infrastructure, can also serve as decision parameters. As a result, the vehicle-side and/or external decision parameters can be used to determine the relevance or the need to use and/or approach a charging station in the relevant region and to determine, initiate or terminate corresponding maneuvers. In addition, these parameters can be used to activate, cancel or terminate certain vehicle-side functions.

In at least some embodiments, determining (S03) the intention of a vehicle driver may further be based on information about traffic rules, whereby a potentially higher consumption, for example due to frequent starting, could be taken into account here. Determining the intention of a vehicle driver, in particular the driving intention, can determine the intention of the vehicle driver in such a way that no traffic rules are violated. The use of traffic rules, for example distance rules or speed limit rules, makes it possible to limit the possible or probable intentions of the vehicle driver and allows the intention of a vehicle driver to be determined more precisely.

The probability of an intention of a vehicle driver comprises a probability that a vehicle will drive to a charging station or a probability that the vehicle-side system will drive to a charging station or that the vehicle operator will be recommended to do so by the vehicle-side system, for example a navigation system.

There are situations in which it can be assumed with a high probability that there is a certain intention of a vehicle driver to use a charging station (3) in the relevant region, such as the situation of a low fill level of the vehicle. However, situations are also conceivable in which the intention is less likely to exist, e.g. because the vehicle's charge level is sufficient to reach the next destination, but the remaining (predetermined) charge level is low when the destination is reached.

In one embodiment, the individual decision parameters can therefore be assigned a probability of the intention of a vehicle driver to use and/or drive to a charging station in the relevant region if the relevant conditions are met. This includes an analysis of the options for action and also takes into account the locally applicable traffic regulations in this context. Nevertheless, information from the history of the driving behavior of the vehicle and/or the vehicle operator can also be included for assigning probabilities to the individual decision parameters. Typical examples of information from the vehicle's driving history include the usual driving speed, usual consumption, charging behavior and/or the extent to which vehicle consumers (e.g. vehicle air conditioning, seat heating, external consumers connected to the vehicle) are used for the same or similar routes/distances.

In addition, the usual traffic situation at the time of determining (S03) the intention within the defined, relevant region and/or in the vicinity of the charging stations in the relevant region can also be included for assigning probabilities to the individual decision parameters.

Furthermore, the step of determining (S03) the intention of a vehicle driver and/or the step of identifying (S05) the charging station for which the charging process is notified can provide that the method furthermore provides the step of determining a so-called safety radius. For the purposes of the present invention, a safety radius describes a second region which is arranged, for example, within the defined relevant region or at least overlapping the latter, at least one further charging station (also referred to herein as a “secondary charging station”) being provided within this second region, which charging station the vehicle can reach (i.e., the charge level of the vehicle is sufficient at the time of reaching the first charging station) if the first charging station controlled or tested is defective or proves to be defective, or if the first charging station controlled or tested exhibits a significant deviation of the detected data of relevant parameters from the expected parameters, for example during the charging process, and the charging process is (unexpectedly) aborted. Preferably, only charging stations with such a safety radius should be controlled. The method can thus ensure that the vehicle can also control an alternative charging station (secondary charging station) in the event that the first controlled or tested charging station (also referred to herein as the “primary charging station”) proves to be blocked, defective or faulty, without the risk of the vehicle being unable to continue its journey due to a low fill level or being unable to continue its journey at all and coming to a standstill.

Furthermore, it is possible to determine the probability of the charging station failing during the period in which the vehicle to be charged activates/starts up the charging station. For this purpose, for example, data from other vehicles and/or users/vehicle operators is taken into account, in particular the probability of the charging station being used by another vehicle during the charging process or failing during a (successfully initiated) charging process. Herein, historical data on the charging station or historical data on the frequency of use of the charging station within the relevant region can be used.

Once the possible intention of a vehicle driver to use a charging station has been detected, the testing of charging described below must be recognized. In the event that a charging station can be found at the location specified in the charging station directory, this is trivial, as the vehicle operator will attempt to connect the vehicle to the charging station.

A charging station in the spirit of the invention is a device that can be connected to the vehicle via a current-carrying line (e.g. a cable) and/or a coil device, e.g. embedded in the road/parking lot pavement, for charging a vehicle by induction. Charging by means of current collectors, such as those used for buses with an electric drive train, also falls under this designation. The part of the charging station that is intended to transmit electricity is referred to as the current-carrying element.

If the intention of a vehicle driver to use a charging station has been determined/determined with sufficient probability, a charging process is tested at this charging station.

Thus, according to the invention, testing is carried out before a charging process has clearly started. During testing, there may or may not be a connection between the device to be charged and the charging station by means of a cable. Whether a connection is made with a cable is taken into account during the evaluation. This advantageously allows different sources of error to be detected, i.e. registered and evaluated, within one method. In addition to detecting errors during the charging process itself, other errors can also be detected where a connection to the charging station cannot be made in the first place. Other errors include a charging station that is not available and a charging station that cannot be reached. Advantageously, further errors can be automatically detected within a database.

Preferably, the method provides for a multi-stage intention probability determination, in particular in the event of a missing charging process. In doing so, an error message can be triggered by the fact that a probability of a driver's intention has only exceeded a first, lower limit value, after which no charging process then followed, although this applies to a majority of drivers, preferably over a certain period of time.

For example, a first threshold value of a driver's probability of wanting to drive to a certain charging station may be exceeded if the driver is already in the vicinity of a rest area but drives past it. If this happens to a number of drivers, for example 20 or 100, over a certain period of time without a charging process taking place, this can be a sign that the charging station is not accessible.

In the event that a cable is connected or a connection is established using inductive coils, a corresponding protocol handshake takes place, depending on the technology used, in which the vehicle and the charging station agree, for example, on the expected charging current or similar. At the latest when the handshake is initiated, it is clear that the driver is trying to charge the vehicle at this charging station. If the handshake does not work, there is a deviation within the meaning of the invention, which triggers a reportable error that can be reported to the operator's infrastructure or a charging station directory.

If no charging station is available at the specified location, or if access is obstructed, for example by other vehicles parked at the charging station, the intention of a vehicle driver to use a specific state-of-the-art charging station can only be recognized on the basis of the current location and possibly on the basis of the vehicle characteristics. Approaching the charging station itself then corresponds to testing a charging process. Characteristics to be taken into account would be, for example, the SoC, decreasing speed before the charging station is supposedly reached, possibly a stop or even the vehicle operator getting out of the car, or similar. If the characteristics are present, the vehicle operator is asked either via a device in the vehicle or via a digital terminal whether the charging station was defective or inaccessible. Historical data could also be used to take into account whether the vehicle operator already knows the charging station(s), as their behavior is then very likely to be different than if they do not know the charging station(s) and are still looking for them. If the driver then registers that the charging station is defective or inaccessible, this constitutes a reportable defect that can be reported to the operator's infrastructure or a charging station directory.

In a preferred embodiment, the charging stations are equipped with a module for transmitting a radio signal, preferably with a so-called radio beacon, again preferably using Bluetooth LE beacons and/or RFID transmitters or by means of a corresponding further development. This makes it advantageously possible to transmit the identity of a charging station and, if applicable, the occupancy status known to the charging station and/or any defects without having to establish a connection. Advantageously, the use of Bluetooth LE or RFID is supported by the fact that these technologies are widely used in mobile devices and a corresponding application (also: app) in a corresponding mobile device can react to the presence of the charging station without the user/vehicle operator having to do anything, for example to ask whether the user wants to use this charging station.

As there are often many charging stations close together, it is usually necessary to identify the charging station once the charging process has started successfully. If there is only one charging station in the vicinity, identification is trivial, as the vehicle is connected to a charging station and is charging, it can only be this charging station if there is only one charging station in the vicinity.

Otherwise, it is possible to identify the charging station by transmitting a signal via the connection (cable or inductive coupling with coils) or a radio standard such as Bluetooth, W-LAN, LoRaWAN or similar. The transmitted signal can be an analog signal such as voltage or current variations, or a digital signal. Regardless of the exact implementation, this method is advantageously characterized by the fact that identifying the charging stations is very simple and error-free.

In a preferred embodiment, the charging station can be extended by or comprise a radio beacon, as described above. This allows the information transmitted by the radio beacon to be used for identifying the charging station to be used or being used, for example by comparing the change in occupancy status or its ID with the information from a charging station directory.

As such identification would probably have to be retrofitted to existing charging stations, which would incur costs for the operator, the charging station can alternatively be identified in another way. For example, when the vehicle is parked, the occupancy status of all charging stations in the immediate vicinity can be queried from known charging station directories. The occupancy status of a charging station changes when a vehicle starts or ends the charging process. According to an advantageous embodiment, the identification of the charging station is thus based on an occupancy query in a database. This advantageously eliminates the need to retrofit additional components in existing charging stations. Furthermore, this does not increase the complexity of the existing charging stations. Since complexity is generally correlated with susceptibility to errors, this also advantageously reduces the susceptibility to errors compared to charging stations with additional components designed to carry out the method.

It may be provided that the step of identifying (S05) a charging station is carried out on the basis of a signal (e.g. via data transmission means or identification means as described below) between charging station and vehicle.

The step of testing (S04) a charging process and the step of identifying (S05) the charging station for which the charging process is notified can also be carried out in reverse order. In fact, it may be provided that the step of identifying (S05) the charging station takes place before the step of testing (S04) a charging process. For example, it may be provided that the vehicle to be charged registers at the charging station before testing (S04) and thereby identifies it (S05). The registration for identifying (S05) the charging station can be carried out using common data transmission means or identification means (also: radio connection), as defined herein, for example. Examples include Bluetooth, WLAN, 2G (GPRS, EDGE), 3G (3G, H, H+), 4G (LTE, LTE-A), 5G, 6G, LoRaWAN, RFID, NFC, UMTS, LTE, ZigBee, WiMax and other mobile radio standards, or a combination of at least one of these. Identifying can also be carried out using an NFC-based and/or an RFID-based connection. The upstream identifying of the charging station for which the charging process is notified furthermore has the advantage that the charging station is blocked in advance for the notified charging process, particularly when using long-distance identification means, and is therefore no longer (initially) available for other vehicles. The step of registration and/or identification can be carried out depending on the determined (S03) intention of a vehicle operator to use and/or access the charging station in the relevant region. An example of the existence of a sufficient probability that a vehicle and/or vehicle operator will head for a charging station in the relevant region and is likely to test it may be that the charging station has been defined as an intermediate or final destination.

For example, the step of identifying (S05) a charging station is carried out on the basis of the current location and/or a comparison with an occupancy status of the charging station used retrieved from a charging station directory.

After the start of the charging process, a device in the vehicle preferably detects relevant data on relevant parameters of the charging process, such as the voltage and current applied, as well as the power called up, the temperature of the battery, the power loss or similar. The device can be, for example, the BMS and/or the OBD and/or an adapter (as described herein), which is arranged in the vehicle.

In an alternative embodiment of the method, the relevant parameters are also determined by the charging station during the charging process and reported to the charging station operator.

The vehicle-side and/or charging station-side detected relevant parameters are selected in particular from the location, i.e. the position data of the charging station, the position data of the vehicle, optionally the position data of the vehicle operator; the voltage, in particular the charging voltage provided by the charging station or the charging voltage applied to the vehicle; the current, in particular the charging current provided by the charging station or the charging current applied to the vehicle; the power called up, in particular the charging power; the dwell time of the vehicle at the charging station; optional vehicle-specific secondary parameters (as defined herein); the temperature of the accumulator; the power loss of the vehicle, e.g. caused by consumers in the vehicle; the current flowing through the charging station; and the charging voltage. the current setpoint of the vehicle; the filling quantity of the vehicle, in particular at the beginning, during and/or after completion of the charging process; load management; and/or fluctuations and interruptions of the charging current and the charging voltage during the charging process.

A detected relevant parameter, in particular a relevant parameter inducing a further process step or the detection of further parameters (as described below), can also be the unsuccessful testing of the charging station for which the charging process is notified, whereby the charging station turns out to be blocked, defective or faulty.

The device in the vehicle is preferably a computing unit that is or can be connected to an in-vehicle network, preferably a BUS system, particularly preferably a CAN BUS or a diagnostic port of the vehicle.

If the charging process stops unexpectedly, there is another reportable defect that can be reported to the operator's infrastructure or a charging station directory, for example.

An example of an (unexpectedly) aborted charging process can occur if the vehicle terminates the charging process and/or leaves the charging station, e.g. without a charging process having been initiated, within a period of time in which the charging process has not yet been or cannot yet be completed, e.g. after a defined or predetermined period of time (in particular a charging time until a state of charge of at least 70%, preferably at least 80%, has been reached). For the purposes of the present invention, the time that the vehicle to be charged is located at the charging station or in its vicinity is referred to as dwell time. If nothing else is mentioned, it is initially irrelevant whether the charging process was initiated and/or completed, so that, for example, a removal from an advised charging station is also included.

The recording of charging station-specific parameters, e.g. charging power, in particular charging current and/or charging voltage, is not necessary in this case. Instead, it may be sufficient to record as relevant parameters within the meaning of the present invention only parameters which are preferably selected from or consist of the position data of the charging station, the position data of the vehicle, the dwell time of the vehicle at the charging station, optionally the position data of the vehicle operator, the fill level of the vehicle and optionally vehicle-specific secondary parameters (as defined herein). The charging station-side detection of parameters, in particular charging power parameters such as charging current, charging voltage, nominal power of the charging station, can be omitted in this case. Herein, in a first scenario, it can be provided, for example, that if the dwell time of the vehicle to be charged at the charging station is less than a lower critical dwell time, in particular only 30% or less, preferably only 20% or less, most preferably only 10% or less, in particular only 5% or less, than the determined charging time, an error message is issued. Herein, the charging time is determined in particular on the basis of the energy requirement of the vehicle to be charged and the power provided at the controlled charging station, preferably until charging to a state of charge of at least 70%, preferably at least 80%, particularly preferably at least 95%. If the charging process is therefore interrupted after a time that is less than the lower critical dwell time, such as only 15 minutes, 10 minutes or 5 minutes, the position data of the charging station, the position data of the vehicle and optionally the position data of the vehicle operator are preferably determined and used to create a movement profile of at least the vehicle to be charged and/or the vehicle operator. For example, this can be used to detect whether the vehicle to be charged (subsequently) controls an alternative charging station (secondary charging station) in order to test and/or initiate a charging process at this charging station, which can be interpreted as a clear sign that the charging station first controlled (primary charging station) was not ready for use, e.g. it was not functional, defective, partially destroyed (e.g. severed charging cable, defective plug connection, defective inductive coupling).

An error message can also be provided according to a second scenario if the dwell time of the vehicle to be charged at the charging station is greater than an upper critical dwell time, in particular more than 10% or longer, preferably more than 20% or longer, most preferably more than 30% or longer, in particular only 40% or longer, than the originally determined charging time. If the charging process is not completed and/or aborted until well after a time that is longer than the upper critical dwell time has elapsed, the position data of the charging station, the position data of the vehicle and optionally the position data of the vehicle operator are preferably determined and used to create a movement profile of at least the vehicle to be charged and/or the vehicle operator. It can also be detected whether the vehicle to be charged (subsequently) controls an alternative charging station (secondary charging station) in order to test and/or initiate a charging process at this charging station, which can be interpreted as a clear sign that the charging station that was controlled first (primary charging station) was defective, e.g. non-functional, only partially functional, partially destroyed (e.g. severed charging cable, defective plug connection, defective inductive coupling with the coils).

According to an advantageously embodiment, the determined charging time is compared with a critical charging time in both of the aforementioned scenarios until the charging process is canceled or terminated, in particular until the charging process is canceled. If such a comparing (S07) of the detected dwell time as a relevant parameter results in a deviation, in particular a significant deviation, as defined above, from the predetermined period of completion of the charging process, a reporting (S08) of the deviation of the detected data of relevant parameters from the expected parameters takes place.

Preferably, a positional behavior of the vehicle is integrated into the comparing (S07) so that, for example, it is detected and included in the assessment if, as described above, another charging station is used after a short time. This advantageously allows further problems at the charging stations to be identified.

Methods for determining position data are known to those skilled in the art and can, for example, take the form of satellite-based determination of the position, such as GPS.

According to a particularly advantageous embodiment, the relevant parameters of the method are exclusively position data from the vehicle.

The detection of the vehicle-side position data as relevant parameters has the significant advantage that, on the one hand, no computing unit for comparing charging parameters needs to be provided in the vehicle in order to carry out the method described herein for checking charging stations and their functional scope and, on the other hand, large amounts of data that map the charging process do not need to be detected, transmitted and/or compared on the vehicle-side and/or charging station-side. This saves resources.

For detecting whether a charging process is aborted before, in particular well before, the end of the regular or planned charging process or has been aborted with a sufficient probability or has not even taken place (e.g. because testing of the charging station could not be realized due to the inaccessibility of the charging station or due to the defect of the charging station), the determination of the position data of the vehicle and/or the vehicle operator, in particular from the time of reaching the controlled charging station to be tested, can be provided. The detection of the current position data of the vehicle and/or the vehicle operator can be carried out accordingly via known devices that allow, for example, a satellite-based determination of the position, such as with GPS. Similarly, the position data of the vehicle and/or the vehicle operator can be determined if a charging process is terminated and/or completed after, in particular well after, the time at which the regular or planned charging process is terminated and/or ends. The dwell time at the charging station can be determined simply from the position data of the vehicle and/or the vehicle operator as the time difference between the time at which the vehicle reaches the charging station and the time at which it leaves the charging station. Furthermore, the actual dwell time on the vehicle and/or charging station side can be determined as the time difference between the time at which the vehicle to be charged is brought into contact/coupled, e.g. by a charging cable or by means of inductive coupling, and the time at which it is decoupled from a controlled charging station. On the charging station side, the time of contacting/coupling and decoupling can be carried out as described herein by a suitable identification module as an identification means, which is arranged, for example, within the plug connection on the charging station side.

Nevertheless, vehicle-specific secondary parameters can be detected which are independent of vehicle-side and/or charging station-side performance parameters, such as charging current, charging voltage, nominal power of the charging station, current setpoint of the vehicle to be charged, and which do not serve as directly influencing variables for the charging process. Such vehicle-specific secondary parameters are, for example, the times of opening and closing the driver's door, the passenger door and/or the tailgate (in which a mobile charging cable is usually placed), the times of locking and/or unlocking the vehicle to be charged, the time of ending and/or initiating a start process of the vehicle to be charged.

To verify the reported deviation of the detected data, in particular taking into account the dwell time of the vehicle to be charged at the charging station, the position data of the charging station, the position data of the vehicle, the dwell time of the vehicle at the charging station, optionally the position data of the vehicle operator, and optionally the vehicle-specific secondary parameters (as defined herein), the two-factor identification (as described herein) can be used.

If the charging process can be successfully completed, the data detected during the charging period is compared with the data expected for the charging station. For example, it is checked whether the charging station has charged with the correct voltage or whether the maximum power stored in the charging station directory has been reached. All the parameters detected are taken into account. This is necessary because different charging capacities are possible depending on the temperature of the battery and the SoC as well as the firmware version of the battery management system (BMS), so that a charging capacity below the maximum charging capacity specified for the charging station does not necessarily indicate an error on the part of the charging station. This comparing (S07) can be localized directly on the device in the vehicle that detects the data, on a mobile device (in particular smartphone, tablet and/or notebook) of the vehicle operator or on a remote computing unit, e.g. a server connected to the Internet.

In one embodiment, the step of comparing (S07) the detected data on the relevant parameters with the retrieved or expected data on the relevant parameters takes place on the device in the vehicle.

Preferably, the comparing (S07) of the detected data is carried out by a remote computing unit or on a mobile device (such as a smartphone, tablet, notebook) that is not located in the vehicle (non-vehicle computing unit). This has the advantage that no additional components, such as a computing unit, need to be installed in the vehicle. This makes it advantageously possible to dispense with the subsequent installation of a computing unit, in particular the costly installation of a non-manufacturer computing unit that has to be coupled with other components in the vehicle, such as the battery management system (BMS), sensors and/or actuators in the vehicle. Furthermore, complex algorithms may be required for the step of comparing (S07) the detected data, as this is the only way to detect impending errors at an early stage. This requires high computing power, which is easier to achieve in separate computing units. In particular, undesirable fluctuations over the entire charging process can be determined by a computing unit external to the vehicle. Furthermore, this offers the advantage that third-party providers can be included and/or a fleet-specific charging system can be set up, e.g. as a closed charging ecosystem and/or on a non-public area, such as a factory site, without having to carry out major technical modifications to the vehicle, for example. For several reasons, it therefore makes sense to decouple the step of comparing (S07) from the vehicle and outsource it to a non-vehicle computing unit.

Insofar as the comparing of the detected data takes place on a mobile device or on a remote computing unit, the method also comprises transmitting the data detected on the vehicle-side and/or charging station-side to a mobile device or to a remote computing unit, whereby the transmission of the detected data to a remote computing unit can take place directly from the charging station and/or from the vehicle, or indirectly via an intermediate computing unit, e.g. a mobile device. In particular, mobile devices offer corresponding interfaces that enable the mobile device to be coupled with the charging station and/or the vehicle.

According to a particularly preferred embodiment, a computer program product can be provided for comparing (S07) on a remote computing unit or on a mobile device, which receives the detected data directly from the vehicle and/or the charging station or via an independent computer program product, e.g. a vehicle manufacturer-specific computer program product, the latter being set up to receive the detected data directly from the vehicle and/or the charging station. According to a preferred embodiment, a computer program product is provided, in particular on a remote computing unit and/or a mobile device, which is set up, for example having a suitable interface, to receive vehicle-side and/or charging station-side detection data from a storage medium and/or a computer program product, for example a vehicle manufacturer-specific and/or charging station manufacturer-specific storage medium and/or computer program product. This has the advantage that a third-party provider can be included and/or a fleet-specific charging system can be set up, e.g. as a closed charging ecosystem and/or on a non-public site, such as a factory site, without having to carry out major technical conversion measures, for example.

For comparing (S07) on a remote computing unit or on a mobile device, an adapter can also be provided, which in one embodiment represents an information technology unit, in particular a computing unit assigned to the vehicle, in particular (exclusively) a recording, storage and/or transmission unit, whereby one or more measuring devices can be integrated in this adapter. Thus, the parameters and/or data detected on the vehicle can be stored on the adapter or the adapter serves as a means for transmitting the parameters and/or data detected on the vehicle to a remote computing unit or a mobile device. Preferably, the adapter is arranged in the vehicle to be charged and, for example, connected to the vehicle via the on-board diagnostic system (OBD) and/or can be coupled/connected directly to the vehicle to be charged, in particular coupled/connected within the vehicle. The adapter is particularly preferably a computing unit assigned to the vehicle to be charged, in particular a computing unit external to the device, which is preferably coupled/connected to a battery management system (BMS) of the vehicle to be charged. The adapter is advantageously set up for direct (through direct data transmission between the computing unit and the adapter) or indirect (through indirect data transmission between the computing unit and the adapter, e.g. via a mobile device such as a smartphone, tablet or notebook) data transmission with the remote computing unit. This means that the adapter has a communication interface that is set up to carry out data communication between this computing unit and the adapter.

This adapter can then access the stored data in the vehicle to be charged and transmits the vehicle-side detected parameters and/or data to the remote computing unit and/or the mobile device. In one embodiment of the invention, the adapter has one or more measuring devices, in particular sensors, and is designed independently of the vehicle's own BMS or OBD in such a way that it is integrated into the charging process as a vehicle-side interface and independently and autonomously detects relevant parameters on the vehicle side.

The vehicle-side data that is detected by the adapter, stored and/or transmitted to a remote computing unit or a mobile device for further processing and for comparing (S07) can, if available and/or provided, be combined or supplemented with data from the charging station via an interface. According to a preferred embodiment of the method according to the invention, the charging station-side detection data can be transmitted in particular to the remote computing unit or a mobile device for comparing (S07) the detected data of the relevant parameters.

In order to avoid or even rule out an incorrect classification of a charging station as faulty, defective or blocked, the present method for checking charging stations can also include a step of identifying whether the deviation of the detected data of relevant parameters from the expected parameters is due to a problem on the vehicle side (also referred to herein as “two-factor identification”). This identification step can be carried out on the vehicle- and/or charging station-side.

In one embodiment, the two-factor identification is carried out directly or indirectly by the charging station. Here it may be intended that the method, e.g. after the step of reporting (S08) a deviation in the detected data of relevant parameters or reporting defects, comprises a step of determining a fault on the charging station side (self-test on the charging station side). For example, determining an error on the charging station side can include checking whether testing has been carried out at all. For this purpose, a remote computing unit or a mobile device can transmit a check signal to the charging station, which initiates the self-test on the charging station side. This is particularly relevant if the charging process has been (unexpectedly) interrupted or testing has not taken place at all. For the determination of unsuccessful or failed testing of the charging station, a sensor (identification module) can be provided in the charging station, in particular in the plug connection on the charging station side, which is set up to detect the testing attempt, i.e., for example, the attempt to bring the vehicle into contact/couple it with the charging station, in particular with the charging station input, via a charging cable. If, at the time of or within the period of the vehicle-side and/or charging station-side detection (S06) of relevant parameters, no contact was made or no attempt to make contact was detected, the probability of a problem directly attributable to the charging station can be assessed as low and the charging station is preferably not classified and/or recorded as faulty or defective.

Such a sensor for detecting the trial via a charging cable or by means of inductive coupling can also include a device that is set up to use parts of the electromagnetic spectrum not visible to humans for signal transmission for identification. Such a device comprises as identification means (also: radio connection), for example, Bluetooth, WLAN, 2G (GPRS, EDGE), 3G (3G, H, H+), 4G (LTE, LTE-A), 5G, 6G, LoRaWAN, RFID, NFC, UMTS, LTE, ZigBee, WiMax and other mobile radio standards, or a combination of at least one of the above. The advantage of a combination is the possibility of not being limited to one mobile radio standard. The identification module preferably comprises an NFC-based and/or RFID-based connection as the identification means. Implementation is simple, which also allows existing charging stations to be retrofitted. In addition, NFC-based and/or RFID-based connections are less susceptible to interference.

A sensor (identification module) for detecting the test run via a charging cable can be designed as a motion sensor or distance meter, which is preferably arranged within the plug connection on the charging station side. Also, a sensor (identification module) for detecting the test run via an inductive coupling can be designed as a motion sensor or distance meter, which is arranged in such a way that it detects the positioning of a vehicle, in particular the vehicle to be charged.

In one embodiment, the two-factor identification is carried out directly on the vehicle side (i.e. by the vehicle, in particular a computing unit arranged therein) or indirectly (e.g. by a remote computing unit; a mobile device on the vehicle side or on the driver's side). For example, a remote computing unit or a mobile device may transmit a check signal to the vehicle to be charged, which causes the vehicle to report vehicle-side detected and stored parameters and/or data of the BMS and/or the on-board diagnostic system to the remote computing unit or the mobile device, or initiates a vehicle-side self-test. The initiated, vehicle-side self-test can, for example, trigger a virtual charging process, whereby sensors and/or actuators in the vehicle are activated, whereby vehicle-side sensor and/or actuator parameters are detected and the data detected in this way is then compared with the expected parameters. Nevertheless, a corresponding adapter (as defined herein) can also be controlled, which preferably detects and stores parameters and/or data on the vehicle side or receives these parameters and/or data from the BMS and/or the on-board diagnostic system.

If the vehicle-side two-factor identification is carried out indirectly via a mobile device, e.g. via a device assigned to the vehicle operator, an input on the mobile device may be required. In this case, it may be necessary to transmit a check signal to the mobile device. This is particularly relevant if the charging process is (unexpectedly) interrupted, for example if the vehicle leaves the charging station within a period of time that is shorter than the predetermined charging time, or if testing has not taken place at all. Thereby, the system, in particular a remote computing unit or the mobile device, determines that no or only insufficient data records are available within the notified charging process. If no input or no input confirming the deviation of the detected data of relevant parameters is made on the mobile device in response to the transmission of the check signal, the charging station is initially not classified and/or recorded as faulty, defective or blocked. The two-factor identification thus advantageously also allows checking of the vehicle to be landed and its functional scope.

According to an advantageous embodiment a swarm analysis is also integrated, in which certain deviations are only classified as errors after this deviation occurs in several vehicles using the same charging station, in particular without a successful charge in between. This allows faulty or error-prone charging stations to be identified. Such a swarm evaluation can be used in particular for comparing based exclusively or also on the evaluation of position data of vehicles and/or vehicle operators. Preferably, a level system is used in which a charging station can be classified in an intermediate category or is classified if there was a deviation of the detected data of relevant parameters from the expected parameters. If this deviation occurs several times, at least twice, in particular within a defined period of time, this charging station is reported as faulty. The fact that a charging station is classified in such an intermediate category is preferably taken into account when determining the probability of failure of a particular charging station.

Furthermore, the swarm evaluation can also be used to determine a fault on the vehicle side and its functional scope. In this case, the method according to the invention, as described herein, can also be used for checking vehicles (5) and their functional scope as well as for repeatedly checking charging stations (3) and their functional scope (verification). The present invention therefore also relates to a method for checking vehicles (5) and their functional scope as well as for repeatedly checking charging stations (3) and their functional scope (verification), wherein the method defined herein additionally provides for the following steps, namely that the steps of the method are run through again for another vehicle operator (further vehicle operator) and/or another vehicle (further vehicle) within a specific period (deliberately), the charging station reported, in particular reported as defective, faulty or blocked, being approached again, in particular approached, and/or notified for a charging process. It is understood that in this case the defined (S01) relevant region as well as the determined (S03) intention of a vehicle operator to use a charging station may deviate and/or be different for the other vehicle operator and/or the other vehicle. The specific period for re-running the steps of the method can be freely selected and is, for example, no more than 24 hours, preferably no more than 12 hours, in particular no more than 6 hours, after the first run. If, when the steps of the method are run through again, it turns out that the charging process is determined or reported as successful and/or error-free for the other vehicle operator and/or other vehicle, the charging station in question can either be stored in the system as error-free or the probability of failure of this charging station can be adjusted accordingly. Furthermore, a corresponding check signal can be transmitted to the vehicle operator and/or the vehicle that has previously gone through the steps of the method, e.g. directly to the vehicle or indirectly via a mobile device of the vehicle operator. The check signal can contain a reference for checking the charging facility on the vehicle. In this way, the present method advantageously allows faults and/or defects on the vehicle side to be detected or the vehicle operator and/or vehicle passing through to be informed that the charging station in question is operational again and is therefore no longer reported as faulty, defective or blocked.

Insofar as any obvious defects or significant deviations between the target values shown, for example in charging station directories, arise in the course of the method, these are finally reported either by the device for recording the data itself or by a mobile device, either indirectly via another server or directly to at least one charging station directory. In addition, violations of any laws and regulations, such as parking at a charging station without charging (also: unauthorized parking) could be reported to the appropriate authorities (e.g. public authorities).

Insofar as the relevant parameters are also detected on the charging station side, in a preferred embodiment this also reports the measured data to a remote computing unit, e.g. to the charging station operator or its infrastructure, so that the latter is advantageously informed of anomalies as quickly as possible in order to rectify them. According to a preferred embodiment of the method, the parameters and/or data detected on the charging station side can be included for comparing (S07) the detected data of the relevant parameters.

Insofar as a charging station device, in particular the charging station for implementing the method according to the invention, is extended by further components for detecting the relevant parameters during charging or also for detecting other errors or for reporting detected anomalies, further functions can also be added to fulfill the purpose of the method. A charging station is preferably extended by a sensor for detecting occupancy of the charging station, for example by means of a LIDAR sensor, a radar or a sonar, but also, for example, by a weight sensor embedded in the parking lot. This has the advantage of being able to detect unauthorized occupancy without a charging process, such as by parking offenders, which is not possible with charging stations from the state of the art.

Preferably, any deviations found between the retrieved or expected data and the detected data for the relevant parameters, as well as any defects in the charging station, are reported to the charging station operator and/or a directory of charging stations.

Preferably, the procedural recording is carried out via at least one computer program, which is stored on at least one medium in the device in the vehicle and is executed in the device. The computer program can store the data on a medium for later analysis.

The comparing of the detected data with the expected data is preferably also carried out via at least one computer program which is stored on a medium, whereby the medium can optionally be part of the device in the vehicle, part of a mobile device or part of a server.

Depending on specific implementation requirements, embodiments of the invention may be implemented in hardware or in software. The implementation may be performed using a digital storage medium, for example a floppy disk, a DVD, a Blu-Ray disc, a CD, a ROM, a PROM, an EPROM, an EEPROM or a FLASH memory, a hard disk or other magnetic or optical memory, on which electronically readable control signals are stored, which can or do interact with a programmable hardware component in such a way that the respective method is carried out.

A computing unit can be formed by a processor, a computer processor (CPU=Central Processing Unit), a graphics processor (GPU=Graphics Processing Unit), a computer, a computer system, an application-specific integrated circuit (ASIC=Application-Specific Integrated Circuit), an integrated circuit (IC=Integrated Circuit), a single-chip system (SOC=System on Chip), a programmable logic element or a field-programmable gate array with a microprocessor (FPGA=Field Programmable Gate Array).

Generally, embodiments of the present invention may be implemented as a program, firmware, computer program or computer program product comprising a program code or data, wherein the program code or data is or are effective to perform one of the methods when the program runs on a processor or programmable hardware component. The program code or data may, for example, also be stored on a machine-readable carrier or data carrier. The program code or data may be in the form of source code, machine code, byte code or other intermediate code.

### DESIGN EXAMPLES

The present invention is explained in more detail with reference to the following figures and embodiments, without limiting the invention to these.

### Thereby Shows

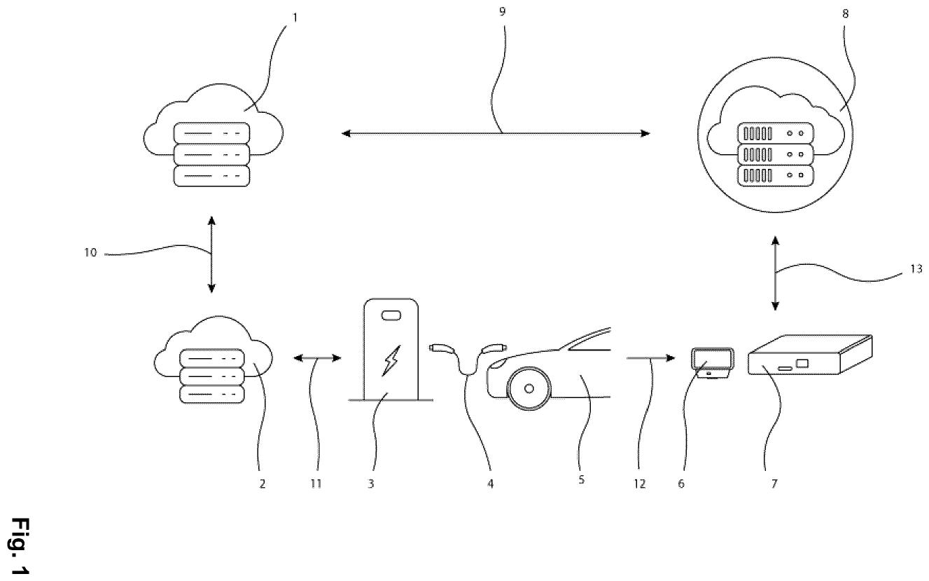

FIG. 1: A schematic representation of the interaction of the components involved in one embodiment

FIG. 1 shows a schematic representation of the interaction of the components involved. To explain the interaction, an electric vehicle (5) with a charging station as a filling device (3) is shown. The connection between the two is made via a cable (4). To enable the charging process, the charging station (3) establishes a connection (11) to a billing server, which is part of the infrastructure (2) of the charging station operator. When the server confirms that the payment for the charge has been released, the charging process begins. In this case, the vehicle's BMS (5) reports the charge and relevant parameters such as charging current, battery level, etc. on the vehicle's internal CAN bus. The connection unit (6) plugged into a diagnostic port of the vehicle (5), for example an OBD port, receives the relevant data and transmits it to the recording device (7). The device for detecting data on the relevant parameters (7) regularly transmits (13) the detected information to a system for evaluating the detected data (8). In this case, the system for processing the detected data (8) This system communicates (9) with a charging station directory (1) for the purpose of comparing the detected data with the expected data and retrieves the data stored there. Charge point operators (CPOs) or providers of RFID cards for activating and billing charging stations (mobility service providers, MSPs) often operate their own directories of charging stations. In this case, the charging station directory (1) could be part of the infrastructure of the charging station operator (2). As a rule, the system will communicate (9) comparing the detected data (8) with several charging station directories (1). The charging station directory (1) also communicates (10) with the infrastructure of the charging station operator (2). For example, the changed occupancy status of the charging station (3) is reported if a charging process starts or ends. In addition, defects or changes in the charging power, for example, are also transmitted.

### LIST OF REFERENCE SIGNS

1 Publicly accessible charging station directory comprising information on a charging station (3)
2 Digital infrastructure of the charging station operator, e.g. for the operating the billing.
3 Charging station for charging the electric vehicle (5)
4 Charging cable for establishing the connection between charging station (3) and vehicle (5)
5 Vehicle
6 Connection between a device for detecting relevant parameters during the charging process (7) and a diagnostic port of the vehicle (5), in this case wirelessly connected to the device.
7 Device for detecting relevant parameters during the charging process of the vehicle (5)
8 System for evaluating the detected data (7)
9 Exchange of data between the system for evaluating the detected data (8) and the publicly accessible charging station directory (1), e.g. for reporting new faults that have occurred at a charging station.
10 Exchange of data between the digital infrastructure of the charging station operator (2) and the public charging station directory
11 Exchange of data between the digital infrastructure of the charging station operator (2) and the charging station (3), e.g. for billing purposes or to transmit the occupancy status, or similar
12 Exchange of data of the vehicle between the device for detecting relevant parameters during the charging process (7) by means of the connection (6) of the device for detecting the charging data.
13 Exchange of data between the device for detecting relevant parameters during the charging process in the vehicle (7), in this case realized by a direct connection, e.g. via mobile radio

1-37. (canceled)

38. A method for checking charging stations (3) and their functional scope comprising the following steps:
a) Defining (S01) at least a relevant region,
b) Retrieving (S02) at least an available information of at least a charging station (3) in the relevant region,
c) Determining (S03) an intention of a vehicle operator to use the charging station (3) in the relevant region, wherein a probability of an existing intention is determined from the retrieved information,
d) Testing (S04) of a charging process if the intention of the vehicle operator to use the charging station (3) has been determined with a sufficient probability,
e) Identifying (S05) the charging station (3) for which the charging process has been notified,
f) Vehicle-side and/or charging station-side detection (S06) of a at least two or at least three relevant parameters,
g) Comparing (S07) the detected data of the at least two or at least three relevant parameters with at least an available information on the charging station (3) being used,
h) Reporting (S08) a deviation of the collected data of the relevant parameters from the expected parameters,
characterized in that
the determining (S03) of the intention is carried out by a driver guidance system, wherein the retrieved information in step c) includes location, maximum charging power, offered plug types, maximum voltage, maximum current, access requirements, operator and electricity costs.

39. The method according to claim 38, wherein the relevant parameters are selected from or consist of the position data of the charging station (3), the position data of the vehicle (5), the dwell time of the vehicle (5) at the charging station (3), the position data of the vehicle operator, and vehicle-specific secondary parameters.

40. The method according to claim 38, wherein the detected data on the relevant parameters are transmitted to a server for comparing (S07) with the retrieved or expected data on the relevant parameters and the comparing takes place on the server.

41. The method according to claim 38, wherein the detected data on the relevant parameters is used for comparing (S07) with the retrieved or expected data on the relevant parameters on a mobile device.

42. The method according to claim 38, wherein the testing (S04) is already started when there is sufficient probability of the intention of the vehicle operator to use the charging station, so that the testing (S04) is already realized by approaching the notified charging station in the absence of a cable connection between the charging station and the device to be charged.

43. The method according to claim 38, wherein an unchanged state of charge after a removal from the charging station following the approach of an advised charging station is detected as the deviation from the existing relevant parameters, which preferably triggers the reporting (S08) of a defect.

44. The method according to claim 38, further comprising providing a driving intention message via a vehicle-to-vehicle interface to one or more further vehicles based on the intention of the vehicle operator.

45. The method according to claim 38, wherein the available information on the charging stations in the relevant region in the step of retrieving (S02) is only retrieved again if it has changed at least partially.

46. The method according to claim 38, wherein only information about the charging stations that have changed is retrieved.

47. The method according to claim 38, wherein the step of determining (S03) the intention of the vehicle operator to use the charging station is based on a current location and/or other data.

48. The method according to claim 38, wherein the step of determining (S03) the intention of the vehicle operator to use the charging station is based on characteristics of the vehicle.

49. The method according to claim 38, wherein the step of identifying (S05) the charging station is based on a signal between the charging station and the vehicle.

50. The method according to claim 38, wherein the step of identifying (S05) the charging station is carried out on the basis of the current location and/or a comparison with an occupancy status of the charging station used retrieved from a charging station directory.

51. The method according to any one of claim 38, wherein the step of acquiring (S06) data relating to the relevant parameters is performed via a device in the vehicle.

52. The method according to claim 38, wherein the step of comparing (S07) the collected data on the relevant parameters with the retrieved or expected data on the relevant parameters takes place on the device in the vehicle.

53. The method according claim 40, wherein the deviation found between the retrieved or expected and the collected data on the relevant parameters as well as any defects of the charging station are reported to the charging station operator and/or directories of charging stations.

54. A computer-readable medium on which at least a computer program product stored, wherein the computer program product comprises instructions which, when the program is executed by a computer, cause the computer to acquire data on relevant parameters during the charging process according to (S06) and/or to execute the method according to claim 38.

55. A computer-readable medium comprising instructions which, when executed by the computer, cause the computer to execute the method according to claim 38 and to store the detected data on relevant parameters during the charging process.

56. A vehicle comprising a data processing device, wherein the data processing device comprises at least the computer-readable medium, wherein the computer program product comprises instructions which, when the program is executed by the computer, cause the computer to acquire data on relevant parameters during the charging process according to (S06) and/or to execute the method according to claim 38, and at least the computer-readable medium comprising instructions which, when executed by the computer, cause the computer to execute the method according to claim 38 and to store the detected data on relevant parameters during the charging process, wherein the computer-readable medium can in particular fulfill acquisition of data on relevant parameters during the charging process according to (S06) and/or to execute the method according to claim 38 and to store the detected data on relevant parameters during the charging process simultaneously.

57. A computer-readable medium on which the computer program product is stored, wherein the computer program product comprises instructions which, when the program is executed by the computer, cause the computer to receive data and error messages detected by the computer program product, wherein the computer program product comprises instructions which, when the program is executed by the computer, cause the computer to acquire data on relevant parameters during the charging process according to (S06) and/or to execute the method according to claim 38 and to detect the deviations between the data and the information retrieved by the charging station operator.
